(19) United States
(12) Patent Application Publication
(10) Pub. No.: US 2004/0030609 A1
(43) Pub. Date: Feb. 12, 2004

(54) Data-managing system and a data-managing method

(76) Inventor: Claudio Eschecolla, (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/398,014

(22) PCT Filed: Mar. 7, 2002
(86) PCT No.: PCT/BR02/00032

(30) Foreign Application Priority Data
Apr. 3, 2001 (BR) PI 0101301-7

(51) Int. Cl. G06F 17/60

(52) U.S. Cl. 705/26

(57) ABSTRACT

One describes a data-managing system comprising a controlling system (S), a memory device (M) controlled by the system (S), a databank (DB) stored in the memory device (M), a transmission means (T) between the system (S) and an electronic device (C), the system (S) having, stored in the databank (DB), data (2) generated at random and assigned to a single product (1)among a plurality of products (1), the system (S) being capable of receiving data (2′) of a product (1′), the data (2′) being fed to the electronic device (C) by a user (CF) and transferred to the databank (DB) via transmission means (T), the system (S) being capable of comparing the received data (2′) with the data (2) stored in the databank (DB), the system (S) being capable of selectively accumulating one or more points (B) in the databank (DB) and assigning the points (B) of the user (CF), and the system (S) accumulating or assigning one or more points (B) according to the result of the comparison of data (2,2′). One further describes a data-managing method comprising the steps of: generating a random number (2): assigning the random number (2) to a product (1); storing the random number (2) in a databank (DB); comparing the number (2′) fed by a user (CF) in the databank (DB) by means of a remote computer (C) with the random number (2); assigning at least one point (B) to the user (CF) in the databank (DB) when the comparison between (2, 2′) is confirmed as being valid by the databank (DB) when the comparison between (2, 2′) is confirmed as being valid by the databank (DB); and deleting the random number (2) from the databank (DB).

The present invention relates to a data-managing system and a data-managing method.

### DESCRIPTION OF THE PRIOR ART

At present, companies or commercial establishments that wish to give gifts to their clients with their own products should resort to nonautomatic gift-giving means. Usually, companies and commercial establishments distribute to their clients stamps, receipts, coupons, or notes proving the effected purchase.

Then, it is up to the clients to keep them and control their counting. As soon as they have the number of vouchers required by the company, the clients return to the service-rendering company and receive the corresponding gifts, prize or product.

It is not difficult to view the drawbacks entailed by such a gift-giving system. First, the onus of controlling and keeping vouchers is up to the consumer. Many lose such papers, forget that they are accumulating them or simply throw away the vouchers that would give them the right to a new product or gift, for the mere trouble of having to keep them.

### OBJECTIVES OF THE INVENTION

The objective of the present invention is to provide a data-managing system particularly usable in managing and organizing data relating to the assignment and accumulation of points to a determined user, which enable the company to reward their most faithful clients with gifts of their own preference in an automatic, practical and suitable way, without the need for keeping or accumulating vouchers.

Another objective of the present invention is to provide a data-managing method that uses the data-managing system described above.

### BRIEF DESCRIPTION OF THE INVENTION

The objective of the invention is to provide a data-managing system comprising a controlling system, a memory device controlled by said system, a databank stored in the memory device, a transmission system between said system and the electronic device, said system storing in the databank the data generated at random and assigned to a single product among a plurality of products, said system being capable of receiving data referring to a product, the data being fed into the electronic device by a user and transferred to the databank by using the transmission means, the system being capable of comparing the received data with the data stored in the databank, the system being capable of selectively accumulating one or more points in the databank and assigning the user's points and the system accumulating or assigning one or more points according to the result of the comparison of data.

In addition, the present invention has also the objective of providing a data-managing method that comprises the steps of: generating a number at random, assigning said random number to a product, storing the random number in a databank, comparing the number fed by a user in the databank by means of a remote computer with the random number, assigning at least one point to the user in the databank when the comparison between the data is confirmed to be valid by the databank and deleting the random number from the databank.

The data managing system and method of the present invention automatizes completely the management and organization of information relating to the assignment and accumulation of points to a determined user, greatly facilitating the task of rewarding the most faithful clients, without the latter needing to worry about controlling vouchers or promotional stamps.

### BRIEF DESCRIPTION OF THE DRAWINGS

The present invention will now be described in greater detail with reference to an embodiment represented in the drawings. The figures show:

FIG. 1: a schematic representation of the data-managing system of the present invention; and

FIG. 2: is a schematic representation of a second preferred embodiment of the data-managing system of the present invention.

### DETAILED DESCRIPTION OF THE INVENTION

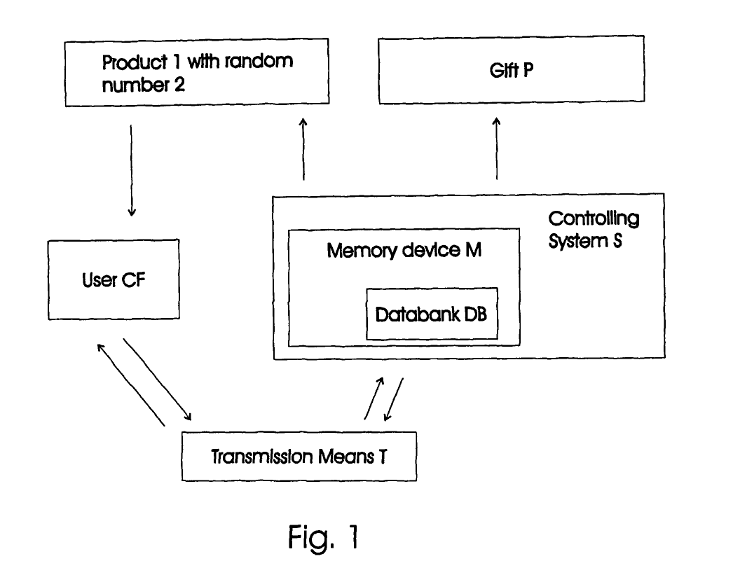

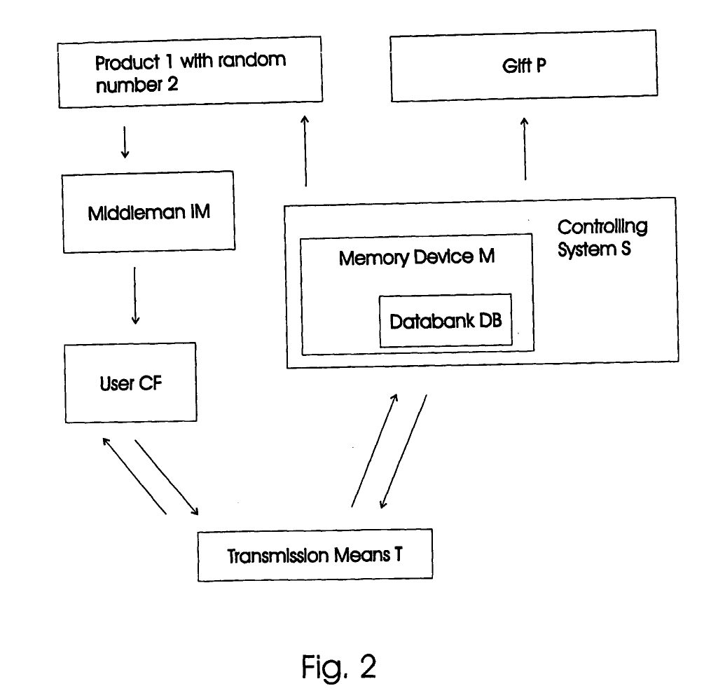

According to a preferred embodiment and as can be seen in FIGS. 1 and 2, the data-managing of the present invention includes a controlling system S, which comprises a memory device M and a databank DB (BD) stored in said memory device M. The system S controls the functioning of these latter elements and may be accessed by an adequate electronic device, such as a remote computer C of a user or final consumer FC (CF) by using a transmission means T.

The controlling system S is preferably a computer program that manages, in the databank DB, information/data 2 assigned to a single product 1 among a plurality of products 1.

The transmission means T is preferably a computer network, such as the Internet or another equivalent transmission means.

The data 2 stored in the databank DB of the system S preferably match the characteristics (such as name, line, price, etc.) of a plurality of products 1, and said system S associates to each of the products 1 contained in the databank DB a number 2, generated at random, which identifies it in a unique way.

The random number 2 may be assigned in various ways, according to what is already known from the prior art. In the preferred embodiment, one has adopted the use of a sequence of mathematical formulas and manipulations that work with some previously chosen numbers in any computer program that automatically carries out mathematical operations. In the preferred embodiment, the random number 2 preferably comprises 9 figures, one of them supplying immediate information about the product 1, such as the line or category of product to which the latter belongs, or else information about its supplier. Another of these 9 figures serve as a verifying digit, with 7 figures remaining free, which always result in different random numbers 2. Said random number 2 may be associated to the product 1 in various ways; in the preferred embodiment, one has opted for printing it on the label of the product 1 or on a cover of the product 1, preferably still in the production line.

The system S further generates an interface I, preferably a graphic one, which will be made available in the remote computer C used by the user CF. This interface I permits interaction between said system S and the user CF, being suitable for transmitting data and making part of the data from said system S available to the user CF.

Expediently, the system S may foresee a limitation of access to the interface I only to one user CF, who is located in a region the data-managing system of which will be available. In this case, the system S asks the user CF for the abbreviation of his state or else recognizes such a region from the postal code supplied by the user CF. Once his region has been confirmed, the interface I is released.

However, the system S may be accessed by means of other interfaces that do not necessarily belong to the system. For this purpose, it is sufficient for these interfaces to have an element connecting the system S.

By means of the interface I, the databank DB can receive data sent by the user CF though the transmission means T, such as: full name and address, city, state, telephone, birth date, marital status, sex, e-mail, password (which should be informed twice for confirmation), a password reminder and permission to send communications. This information will give rise to a register R in the databank DB, which identifies the user CF and to which the controlling system S will associate future data from the corresponding user CF, transmitted to the interface I by means of the remote computer C though the transmission means T.

The interface I of the system S transmits to the user CF a brief concept about the data-managing system and its functioning, comprises texts motivating the user CF to participate in the system, reports results of promotional prize-giving lottery, provides news in general, datum and term reminders. The interface I provides access to secondary interfaces 12′, 1″, 2′″ available in the databank BD.

The first secondary interface 12′ informs how the user CF may participate in the data-managing system, the rules for granting points, how prizes may be received and the occurrence of such prize-giving lottery. It further informs about the validity and terms of the system, as well as the official rules.

The second secondary interface 12″ refers to the secret data relating to the user CF, only available to users CF who already have a registration R in the databank DB. Such secret data refer to the personal data of the user CF, as well to the updating effected by the system S with regard to the registration R of the user CF, whenever the latter transmits data to the memory device M.

The third secondary interface 12″ relates to the most frequent doubts of the users CF for prompt consultation.

By means of the interface I, accessed by the user CF via remote computer C, the controlling system S receives data 2′ relating to the product 1′ acquired on the market by the user CF and transmitted by the transmission means T. The system S interprets the data 2′ and compare them with the data 2 of the product 1 stored therein.

The system S operates selectively, either accumulating or not accumulating one or more points B in the databank DB, assigning such points B to the registration R of the user CF, which transmitted the data 2′. The selection criterion is based on the consistency and validity of the data 2′ supplied by the user CF to the databank DB. Once the points are correct, they are assigned and the data 2, 2′ are invalidated in the databank DB, so that they will not be assigned to a second registration R of another user CF.

The databank DB having stored points B in the register R of the user CF, the system S makes a new operation available. The interface I may send to the databank DB the information which the user CF has chosen from his remote computer C and, via the transmission means T, acquire a new product or gift P with the credit of points B stored in his register R. The system S consults its databank DB first, comparing the information in order to confirm whether the number of points B is sufficient for acquisition of the gift P, this information being previously contained in the databank DB. At a second moment, the above information having been confirmed, the system S consults the databank again, trying to determine whether the gift P is available to be sent to the user CF.

If the above operations are successful, the system S automatically sends to the databank DB the information about recovery of points B and, consequently, charges to the register R the discharge of said points B. Consequently, the system S informs the databank DB of the need to send the gift P to the user CF, at the address which he has registered in the register R.

For the sake of safety, the system S further foresees a limitation to its access by means of passwords, which may be requested whenever the user CF accesses the system S or any of its interfaces 1, 12′, 12″, 12′″.

In operation, the preferred embodiment of the data-managing system of the present invention comprises two main steps, which are described below.

At the first step, the product 1 associated to the data 2 is made available to a plurality of users CF, which, upon acquiring them, access the interface I of the system S by means of a remote computer C. With the remote computer C and via the transmission means T, the user CF feeds the interface I of the controlling system S, these data being stored in the databank DB with his personal information, which make him the owner of a single register R.

The registration R having been included in the databank DB, the controlling system S makes available, in the interface I, a confirmation of the supplied data, stored in the databank DB. The controlling system S automatically generates an electronic message confirming its registration to be sent to the electronic address supplied in the interface I. In addition, the controlling system S may provide an electronic message of welcome to the user CF for his inclusion in the data-managing system in a personalized way, calling him by his first name, further giving more detailed information about the system of the present invention or else messages of interest for the user.

The system S then sends to the databank DB the random number 2′ contained on the product 1′ purchased and supplied to the user CF in the interface I. The system S operates by comparing the data 2, 1′ and, if there is no discrepancy in the information, the system S stores in the databank DB, more precisely in the register R, a determined number of points B previously assigned to the product 1 and, at the same time, the controlling system S invalidates the random number 2, 2′, preventing the latter from being stored in the register R of another user CF. Further in the event of success in said comparison, the system S sends an electronic message confirming to the user CF the inclusion of new points B in his register R, supplying the name of the product 1′, updating it with respect to the total number of points B contained in his register R.

In the comparison between the data 2 and 2′, each of the figures of the random numbers 2, 2′ is compared, also taking into consideration the characteristics associated to such numbers in the databank DB. In case there are any discrepancies, as for example after consulting the databank DB, the system S verifies whether the points B relating to that product 1′ have already been assigned to another user CF. Further, if there is any other kind of error, as for example, the indication of a non-existent random number 2′, the secondary interface 12″ informs the user CF of the error that has occurred, suggests a new attempt at including the random number 2′ or, optionally, suggests that an electronic message be sent to the company informing its problem or doubt. If no discrepancy is found out by the system S, the comparison between 2 and 2′ is defined as being valid.

As new products 1′ are acquired, the user CF repeats the above procedure, this time only accessing his register R via the transmission means T, and indicates the random number 2′ of the new product 1′, thus causing new points B to be assigned by the system S to his register R.

As mentioned previously, the second secondary interface 12″ is confidential and may only be consulted after the user CF has entered the password registered in the register R.

For the sake of safety, the databank DB will store all the information available, if the random number 2′ entered is already cancelled, in order to keep information about possible frauds.

The user CF may obtain a statement with the history of his register R, on which the system S supplied the products 1 registered, the data on which such products were registered, the points B assigned to each of the acquired products 1, the number of points B possibly registered, possible exchanges of products 1 within the system S, his balance of accumulated points B, the validity of said balance, in addition to other information deemed pertinent by the maker of the product 1.

In the second step of the preferred embodiment of the present invention, the system S allows the user, now as the owner of the points B to use his remote computer C to access the interface I and, via the transmission means T, send to the controlling system S the information that his wishes to recover his points B in the form of gift P.

The system S consults the databank DB and verifies what is the number of points B required for obtaining, free of charge, a gift P at his choice. The user CF does not need even to verify whether the number of points B contained in his register R is sufficient for such an acquisition, since the databank DB has this information and the controlling system S automatically i) informs the acquisition of the gift P by sending an electronic message, concomitantly deletes from the register R of the user CF the corresponding number of points B and stores the information in the databank DB that the chosen gift P should be send to the user CF; or ii) the system S cancels the acquisition by informing the user CF, via the transmission means T, that the number of available points B is sufficient for acquisition of the chosen gift P.

In this step, the user CF has at his disposal, in the interface I, the request for cancellation of participation in the system and its rules (in the event of cancellation, the system S automatically sends an electronic message confirming the occurrence thereof), as well as a table for consultation of gifts P that may be exchanged.

According to FIG. 2, a second embodiment of the present invention includes, in the preferred variant, a middleman IM, who sells the product 1 to the user CF. This middleman IM may be a commercial establishment, as well as an independent representative.

In this embodiment, the system S again associates data and attributes a random number 2 to the product 1, the product 1 is distributed to the middleman IM, who sells it to the user CF. The same procedure described above takes place, with the difference that the interface I will receive from the user CF not only the data 2′ of the product 1′, but also information pertinent to the middleman IM. Such information is sent, by means of the interface 1, to the databank DB and, just as happens with the user CF, the system S creates, in its databank DB, a register R2 for the middleman IM, who also may have points B credited to has register R2. The rest of the procedure is the same as in the preferred embodiment, but the middleman IM too, in this embodiment, may also have the right to recover gifts P.

In the event of promotional campaigns and/or prize-giving lotteries, there may be issuance of coupons (either electronic or by other means) to both the user CF and the middleman IM, which may be exchanged for any gifts, such as for example, products accumulated points, etc.

Further according to a preferred embodiment, the present invention also foresees a data-managing method that uses the system of the present invention. This method comprises the steps of:

a) generating a random number 2;

b) assigning the random number 2 to the product 1;

c) storing the random number 2 and its related data in the databank DB;

d) assigning the register R of the user CF, after acquisition of the product 1 contained in the databank DB;

e) comparing the number 2′ entered by the user CF in the databank DB by means of the remote computer C;

f accumulating the point(s) B in the databank (DB);

g) assigning the point(s) B to the register R of the user CF in the databank DB, if the comparison between the data 2, 2′ is confirmed as being valid by the databank DB;

h) deleting the random number 2, 2′ from the databank DB;

i) making the points B in the databank DB available for recovery by the user CF in the form of gifts; and

j) canceling the corresponding points B when they have been recovered in the form of gifts p.

The data managing system and method of the present invention completely automatize the management and organization of information relating to the assignment and accumulation of points B to a determined user CF, greatly facilitating the task of rewarding the most faithful users, without the latter having the trouble of controlling vouchers or promotional stamps.

A preferred embodiment having been described, it should be understood that the scope of the present invention embraces other possible variations, being limited only by the contents of the accompanying claims, which include the possible equivalents.

1. A data-managing system characterized by comprising:
a controlling system (S);
a memory device (M) controlled by the system (S);
a databank (DB) stored in the memory device (M);
a transmission means (T) between the system (S) and an electronic device (C);
the system (S) having, stored in the databank (DB), data (2) generated at random and assigned to a single product (1) among a plurality of products (1);
the system (S) being capable of receiving data (2′) of a product (1′), the data (2′) being fed to the electronic device (C) by a user (CF) and transferred to the databank (DB) via the transmission means (T);
the system (S) being capable of comparing the data (2′) received with the data (2) stored in the databank (DB); and
the system (S) being capable of selectively accumulating one or more points (B) in the databank (DB) and assigning the points (B) of the user (CF); and
the system (S) accumulating or assigning one or more points (B) according to the result of the comparison of data (2, 2′).

2. A system according to claim 1, characterized in that the controlling system (S) makes available an interface (I) in the electronic device (C), the interface (I) comprising a part of the data stored in the databank (DB).

3. A system according to claim 2, characterized in that the interface (I) makes the number of points (B) available to the user (CF).

4. A system according to claim 1, characterized in that the system (S) is capable of storing a register (R) about the user (CF), the register (R) being fed to the electronic device (C) by a user (CF).

5. A system according to claim 4, characterized in that the system (S) accumulates and assigns at least one point (B) to the user (CF) register (R) stored in the databank (DB).

6. A system according to any one of claims 2-5, characterized in that the interface (I) comprises secondary interfaces (12′, 12″, 12′″) comprising at least a part of the data stored in the databank (DB).

7. A system according to any one of claims 2-6, characterized in that the electronic device (C) is preferably a remote computer.

8. A system according to any one of claims 2-7, characterized in that the transmission means T is a computer network.

9. A data managing method characterized by comprising the steps of:
generating a random number (2);
assigning the random number (2) to a product (1);
storing the random number (2) in a databank (DB);
comparing the number (2′) entered by a user (CF) in the databank (DB) by means of a remote computer (C) with the random number (2);
assigning at least one point (B) to the user (CF) in the databank (DB) when the comparison between (2, 2′) is confirmed as being valid by the databank (DB); and
deleting the random number (2) from the databank (DB).

10. A method according to claim 9, characterized in that it additionally includes a step of making available the point(s) (B) in the databank (DB) for the recovery of gifts by the user (CF).

11. A method according to claim 10, characterized in that it additionally includes the step of deleting the point(s) (B) from the databank (DB) after the gifts have been recovered.

12. A method according to claim 9, characterized in that, after storing the random number (2) in the databank (DB), the process additionally includes the step of assigning a register (R ) to the user (CF).

13. A method according to claim 12, characterized in that, at the step of assigning points (B) to the user (CF), the system assigns, in the databank (DB), the points to the register (R).
